(19) United States
(12) Patent Application Publication
(10) Pub. No.: US 2010/0303529 A1
(43) Pub. Date: Dec. 2, 2010

(54) SHEET CONVEYING DEVICE OF IMAGE FORMING APPARATUS

(75) Inventor: Tetsuo Shiba, Kanagawa (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/789,354

(22) Filed: May 27, 2010

Related U.S. Application Data
(60) Provisional application No. 61/181,974, filed on May 28, 2009.

(51) Int. Cl. G03G 15/00; B65H 5/06

(52) U.S. Cl. 399/388; 271/264; 271/273

(57) ABSTRACT

A conveying device includes a first curved guide member, a second guide member which has a radius of curvature larger than the first guide member and guides a recording medium between the second guide member and the first guide member, a pinching and conveying section which is disposed on an entrance side of a conveyance path including the first guide member and the second guide member, pinches the recording medium and conveys the recording medium into the conveyance path, and a support member which is provided on the second guide member at.a position adjacent to the pinching and conveying section, and has a support point on an extended line of a normal line of a nip of the pinching and conveying section.

### CROSS-REFERENCE TO RELATED APPLICATION

This application is based upon and claims the benefit of priority from Provisional U.S. Application 61/181,974 filed on May 28, 2009, the entire contents of which are incorporated herein by reference.

### TECHNICAL FIELD

Embodiments relates to a sheet conveying device of an image forming apparatus, which conveys various kinds of sheets in the image forming apparatus such as a copying machine or an MFP (Multi-Functional Peripheral).

### BACKGROUND

In an image forming apparatus, there is a device, to convey a sheet along a curved conveying guide. Besides, in the image forming apparatus, the apparatus to form an excellent image on various sheets, such as thick paper, special paper, envelope and the like, is demanded. When a thick paper or a sheet having rigidity passes through the curved conveying guide, the sheet can apply a force to the curved guide, a peripheral structure and the like. For example, when the sheet passes through the curved conveying guide, the leading edge of the sheet receives a force from the conveying guide, so that the sheet itself is bent to conform to the curve of the conveying guide.

The thick paper or the sheet having rigidity receives a large force from the curved conveying guide, and tends to swell in the bending direction. The large force to cause swelling in the bending direction is finally applied to the structure to regulate the bending.

Hitherto, the force applied in the direction in which the bending of the thick paper or the sheet having rigidity increases acts on rollers and the like to pinch and convey the sheet to the conveying guide, and there is a fear that the sheet conveyance property of the rollers and the like is impaired.

It is desired to develop a sheet conveying device of an image forming apparatus in which when a sheet is conveyed along a curved conveying guide, it is prevented that a force applied in a direction in which bending of the sheet increases is applied to rollers and the like, and a sheet conveyance property is improved.

### DESCRIPTION OF THE DRAWINGS

FIG. 1 is a schematic structural view showing a copying machine of a first embodiment;

FIG. 2 is a schematic structural view showing apart of a curved conveying mechanism of the first embodiment;

FIG. 3 is a schematic perspective view showing an outside guide plate of the first embodiment;

FIG. 4 is a schematic explanatory view showing the shape of a protrusion of the outside guide plate of the first embodiment;

FIG. 5 is a schematic explanatory view showing a state where a sheet passes in a curved conveyance path of the first embodiment:

FIG. 6 is a schematic explanatory view showing an influence exerted on a separation roller by a sheet when a protrusion is not provided in the curved conveyance path of the first embodiment;

FIG. 7 is a schematic structural view showing apart of a second curved conveying mechanism of second embodiment:

FIG. 8 is a schematic explanatory view showing the shape of a stepped portion of a second outside guide plate of the second embodiment; and

FIG. 9 is a schematic explanatory view showing a state where a sheet passes in a second curved conveyance path of the second embodiment.

### DETAILED DESCRIPTION

According to an embodiment, a conveying device includes a first curved guide member, a second guide member which has a radius of curvature larger than the first guide member and guides a recording medium between the second guide member and the first guide member, a pinching and conveying section which is disposed on an entrance side of a conveyance path including the first guide member and the second guide member, pinches the recording medium and conveys the recording medium into the conveyance path, and a support member which is provided on the second guide member at a position adjacent to the pinching and conveying section, and has a support point on an extended line of a normal line of a nip of the pinching and conveying section.

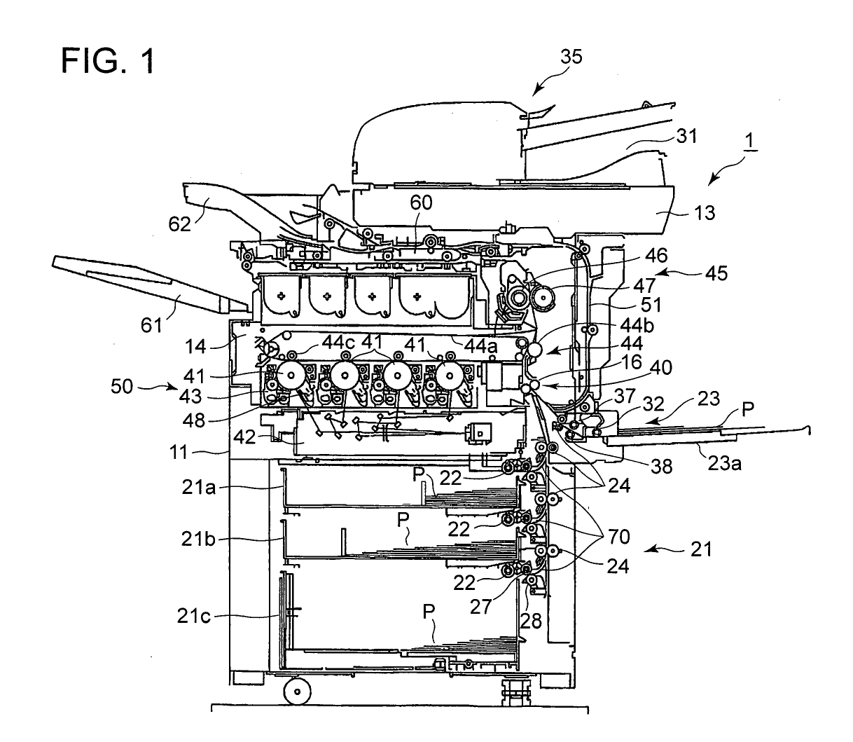

Hereinafter, embodiments will be described. FIG. 1 is a schematic structural view of a copying machine 1 as an image forming apparatus in which a conveying device of a first embodiment is mounted. The copying machine 1 includes a scanner section 13 to read an image and a printer section 14 to form an image. The copying machine 1 includes a paper feed device 21 and a bypass paper feed device 23 as a paper feed section to feed a sheet P as a recording medium.

The copying machine 1 includes a first tray 61 and a second tray 62 as a paper discharge section to receive the sheet P discharged from the printer section 14. In the, copying machine 1, a conveyance path 40 of the sheet P is formed to extend from the paper feed device 21 or the bypass paper feed device 23 to the first tray 61 or the second tray 62 through the printer section 14.

The scanner section 13 scans a document supplied from an auto document feeder (ADF) 35 and captures image information as image data. After the scanner section 13 reads the image information, the ADF 35 discharges the document to a document discharge section 31.

The printer section 14 forms an image corresponding to image information inputted from a terminal or the like or the image information read by the scanner section 13 on the sheet P. The printer section 14 includes four sets of image forming units 50 of yellow (Y), magenta (M), cyan (C) and black (K) as an image forming section, and an exposure device 42. The printer section 14 includes a transfer unit 44 as a transfer section to transfer a toner image formed by the image forming unit 50 to the sheet P, and a fixing unit 45 as a fixing section to fix the toner image to the sheet P on which the toner image was transferred by the transfer unit 44.

Each of the four sets of the image forming units 50 has the same structure, and includes a charging device 48 to uniformly charge a photoconductive drum 41 which is an image carrier, and a developing device 43 to-develop an electrostatic latent image formed on the photoconductive drum 41 by irradiation of exposure light from the exposure device 42 after the charging and to form a toner image. The transfer unit 44 includes an intermediate transfer belt 44a, a primary transfer roller 44c and a secondary. transfer roller 44b. The fixing unit 45 includes an endless heat belt 46 and a press roller 47.

The paper feed device 21 includes an upper paper feed cassette 21a, a lower paper feed cassette 21b and a large capacity paper feed cassette 21c. In the paper feed device 21, a pick up roller 22 is provided above each of the paper feed cassettes 21a, 21b and 21c. The bypass paper feed device 23 includes a bypass tray 23a and a bypass pick up roller 32.

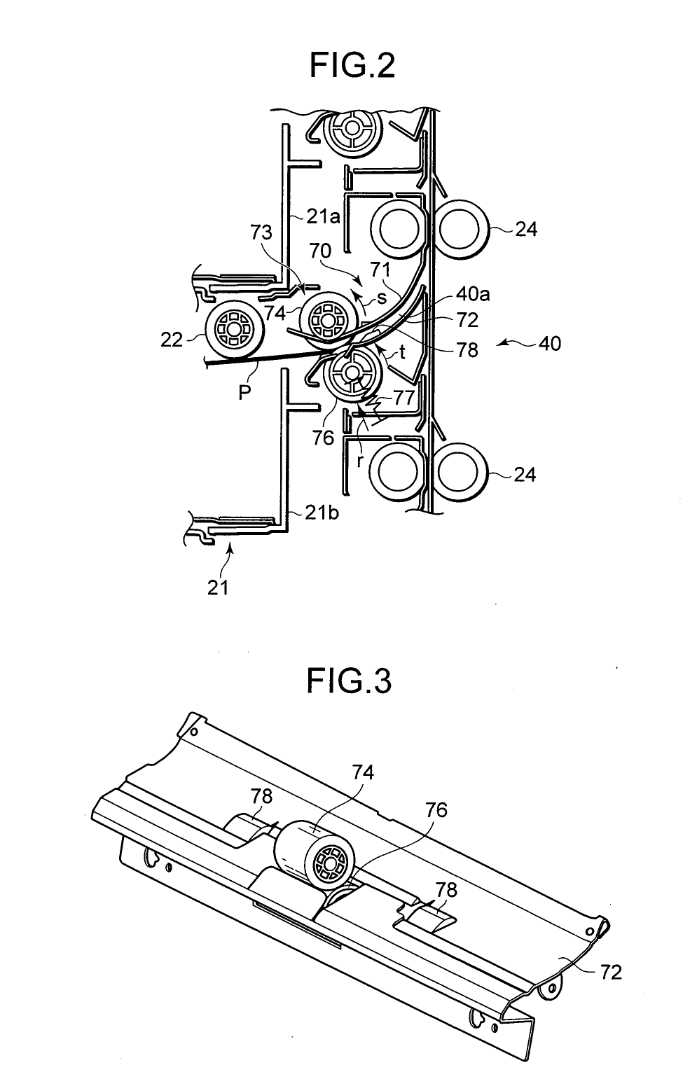

The conveyance path 40 includes a transport roller 24 to supply the sheet P taken out by the pick up roller 22 or the bypass pick up roller 32 to the transfer unit 44, and a register roller 16. A curved conveying mechanism 70 which is a conveying device and is shown in FIG. 2 and FIG. 3 is provided between the pick up roller 22 and the transport roller 24 of the conveyance path 40.

The sheet P having the toner image fixed through the transfer unit 44 and the fixing unit 45 travels in a direction toward the first tray 61, a direction toward the second tray 62 or a direction toward a circulation path 51 of the conveyance path 40. The conveyance path 40 includes a paper discharge conveyance section 60 to discharge the sheet P to the first tray 61 or the second tray 62 or to invert the sheet. The conveyance path 40 includes the circulation path 51 to guide the sheet P to the transfer unit 44 again.

Next, the curved conveying mechanism 70 will be described in detail. The curved conveying mechanism 70 includes an inside guide plate 71 as a first curved guide member, and an outside guide plate 72 as a second guide member which is opposite to the inside guide plate 71 and forms, together with the inside guide plate 71, a curved conveyance path 40a as a part of the conveyance path 40. The curved conveying mechanism 70 includes a one-sheet feeding mechanism 73 as a pinching and conveying section and as a separation section on an entrance side of the curved conveyance path 40a.

The one-sheet feeding mechanism 73 includes a feed roller 74 as a first roller and a separation roller 76 as a second roller which contacts with the feed roller 74. The separation roller 76 presses the feed roller 74 by a spring 77 from the outside direction of the outside guide plate 72 to an arrow r direction. The feed roller 74 is rotated in an arrows direction, and the separation roller 76 is rotated in an arrow t direction.

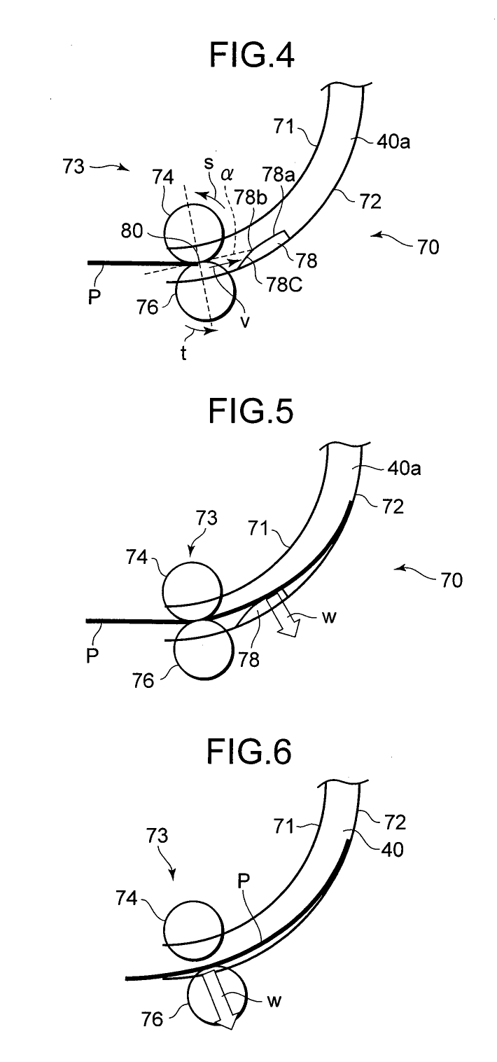

When one sheet P passes through a nip 80 between the separation roller 76 and the feed roller 74 in an arrow v direction shown in FIG. 4, irrespective of the drive rotation in the arrow t direction, the separation roller 76 is driven by the traveling of the sheet P in the arrow v direction, and is rotated in the reverse direction to the arrow t direction. When plural sheets P pass through the nip 80 between the separation roller and the feed roller 74, the separation roller 76 rotates in the arrow t direction. The separation roller 76 prevents the second or later sheet P from traveling in the arrow v direction and prevents the sheets P from being overlapped and conveyed.

The outside guide plate 72 includes a protrusion 78 as a support member on the entrance side and at a position adjacent to the separation roller 76. As shown in FIG. 4, a starting portion 78b as a support point of a support surface 78a of the protrusion 78 is on an extended line of a normal line indicated by a dotted line α at the nip 80 between the feed roller 74 and the separation roller 76. The protrusion 78 includes, on the entrance side, a slope 78c to smoothly guide the Leading edge of the sheet P passing through the nip 80 to the support surface 78a. The support surface 78a is almost' parallel to the outside guide plate 72.

When image formation is started in the copying machine 1, in the printer section 14, after the charging device 48 charges the photoconductive drum 41, the exposure device 42 irradiates exposure light to the photoconductive drum 41 to form an electrostatic latent image corresponding to the exposure light on the photoconductive drum 41. The electrostatic latent image formed on the photoconductive drum 41 is given toner by the developing device 43 and is visualized. The toner image formed by visualizing the electrostatic latent image on the photoconductive drum 41 is transferred to the sheet P through the intermediate transfer belt 44a of the transfer unit 44.

In the paper feed device 21, the sheet P is taken out from the paper feed cassette 21a, 21b or 21c by the pick up roller 22. The pick up roller 22 takes out the sheet at a timing when the sheet Preaches the nip between the intermediate transfer belt 44a and the secondary transfer roller 44b in synchronization with the toner image primarily transferred on the intermediate transfer belt 44a. The feed roller 74 and the separation roller 76 pinch the sheet P supplied by the pick up roller 22 and convey it into the curved conveyance path 40a.

The conveyance direction of the sheet P by the feed roller 74 and the separation roller 76 is the arrow v direction parallel to the normal line at the nip 80. In the curved conveyance path 40a, the sheet P collides with the protrusion 78 before colliding with the outside guide plate 72, and travels in the curved-conveyance path 40a along the support surface 78a of the protrusion 78. Thereafter, as shown in FIG. 5, the sheet P collides with the outside guide plate 72. The outside guide plate 72 guides the traveling direction of the sheet P and guides the sheet P to the transport roller 24.

While the outside guide plate 72 guides the sheet P along the curve, the sheet P generates a force in the arrow w direction in which the bending of the sheet P increases. Thus, when the protrusion 78 is not provided on the outside guide plate 72, as shown in FIG. 6, the force applied in the direction in which the bending generated in the curved sheet P increases is directly applied to the separation roller 76. The force applied in the direction in which the bending generated in the curved sheet P increases depresses the separation roller 76 in the direction of separating from the feed roller 74 against the applying force of the spring 77.

When the sheet P is a standard paper or a sheet whose firmness is weaker than that, the force applied in the direction in which the bending generated in the curved sheet P increases is weak. The force applied in the direction in which the bending generated in the curved sheet P increases does not influence the conveyance property of the one-sheet feeding mechanism 73. On the other hand, when the sheet P is a thick paper or a sheet whose rigidity is high, the force applied in the direction in which the bending generated in the curved sheet P increases is strong. When the force applied in the direction in which the bending generated in the curved sheet P increases is strong, even if the spring 77 presses the separation roller 76 to the feed roller 74 side, the separation roller 76 is separated from the feed roller 74 by the force applied in the direction in which the bending generated in the curved sheet P increases. Thus, in the one-sheet feeding mechanism 73, defective sheet feeding occurs.

However, the curved conveying mechanism 70 is provided with the protrusion 78 on the outside guide plate 72. As shown in FIG. 5, in the curved conveying mechanism 70, the protrusion 78, not the separation roller 76, receives the force applied by the sheet P in the swelling direction. Accordingly, even if the sheet P is curved along the outside guide plate 72, the force in the arrow w direction in which the bending of the sheet P increases has a little influence on the separation roller 76. Even when the sheet P is the thick paper or the sheet having high rigidity, the force of the sheet P in the direction in which the bending increases does not influence the conveyance property of the one-sheet feeding mechanism 73. Even when the sheet. P is the thick paper or the sheet having high rigidity, the one-sheet feeding mechanism 73 sends only the uppermost sheet P to the transport roller 24 surely.

Thereafter, the sheet P passes through the transport roller 24, and after the leading edge is aligned by the register roller 16, the sheet reaches the nip between the intermediate transfer belt 44a and the secondary transfer roller 44b in synchronization with the toner image primarily transferred on the intermediate transfer belt 44a. The secondary transfer roller 44b secondarily transfers the toner image on the intermediate transfer belt 44a to the sheet P passing through the nip between the intermediate transfer belt 44a and the secondary transfer roller 44b. The fixing unit 45 fixes the toner image to the sheet P. After the toner image is fixed, the paper discharge transfer section 60 discharges the sheet P to the first tray 61 or the second tray 62. Alternatively, after the toner image is fixed, the circulation path 51 guides the sheet P to the direction of the secondary transfer roller 44b again.

According to the first embodiment, even when the sheet P traveling along the curved conveyance path 40a is the thick paper or the sheet having high rigidity and the force applied in the direction in which the bending generated in the curved sheet P. increases is high, the protrusion 78 receives the force of the sheet P. Accordingly, the influence exerted on the Separation roller 76 by the force applied in the direction in which the bending generated in the sheet P increases can be made very low. The one-sheet feeding mechanism 73 can certainly feed only one sheet to the transport roller 24 irrespective of the kind of the sheet P. A paper jam due to defective feeding of the one-sheet-feeding mechanism 73 can be prevented.

Next, a second embodiment will be described. According to the second embodiment, in the first embodiment, a support member is formed integrally with a second guide member. In the second embodiment, the same component as the component described in the first embodiment is denoted by the same reference numeral and detailed description is omitted.

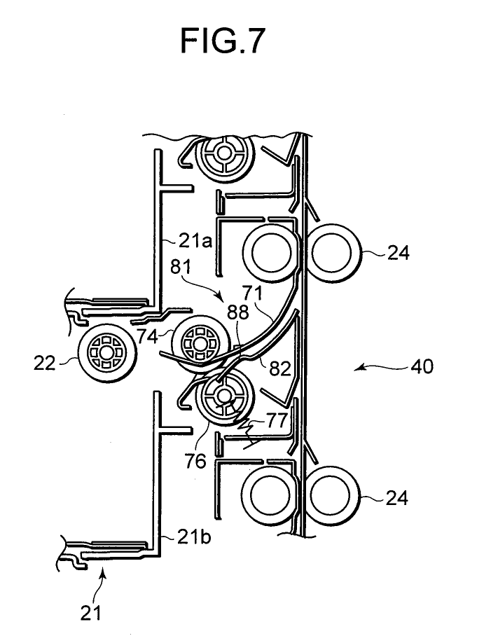

A second curved conveying mechanism 81 which is a conveying device and is shown in FIG. 7 to FIG. 9 is provided between a pick up roller 22 of a copying machine 1 and a transport roller 24. The second curved conveying mechanism 81 includes a second outside guide plate 82 which is opposite to an inside guide plate 71 and, together with the inside guide plate 71, forms a second curved conveyance path 84.

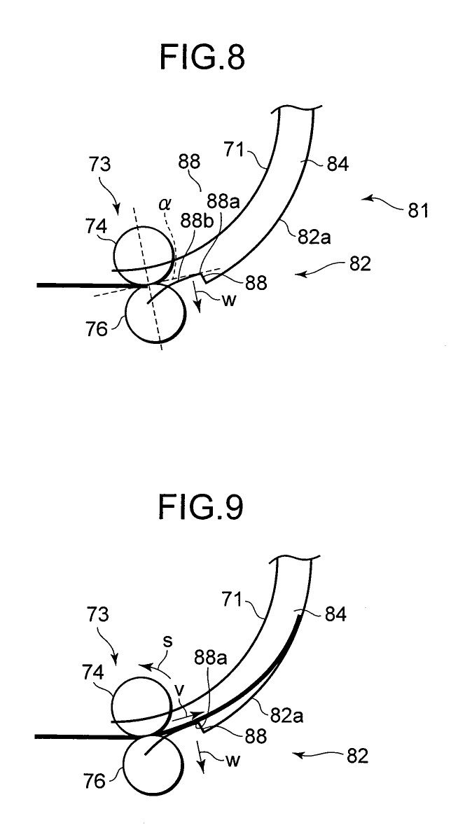

As shown in FIG. 8, in the second outside guide plate 82, a stepped portion 88 as a support member is integrally formed on an entrance side of the second conveyance path 84 of a curved metal plate and at a position adjacent to a separation roller 76. An end portion 88a as a support point of the stepped portion 88 is on an extended line of a normal line indicated by a dotted line α at a nip 80 between a feed roller 74 and the separation roller 76. The stepped portion 88 includes, on an entrance side, a slope 88b for smoothly guiding a leading edge of a sheet P passing through the nip 80 to the end portion 88a. When the slope 88b reaches the end portion 88a, the stepped portion 88 is bent stepwise, and returns to the same height as a surrounding curved portion 82a. Accordingly, although the width of the second curved conveyance path 84 is narrowed by the stepped portion 88, the width can be made wide after passing through the stepped portion.

The feed roller 74 and the separation roller 76 convey one uppermost sheet P taken out by the pick up roller 22 into the second curved conveyance path 84. The sheet P traveling in an arrow v direction parallel to the normal line at the nip 80 by the feed roller 74 and the separation roller 76 first collides with the stepped portion 88 of the second outside guide plate 82 in the second curved conveyance path 84. The sheet P reaches the end portion 88a along the slope 88b of the stepped portion 88, and then, collides with the curved portion 82a of the second outside guide plate 82. The curved portion 82a of the second outside guide plate 82 guides the traveling direction of the sheet P and guides the sheet P to the transport roller 24.

As shown in FIG. 9, in the second curved conveying mechanism 81, while the second outside guide plate 82 guides the sheet P along the curved portion 82a, the stepped portion 88 receives the force in an arrow w direction in which bending generated in the sheet P increases. Accordingly, even if the sheet P is curved along the second outside guide plate 82, the influence exerted on the separation roller 76 by the force in the arrow w direction in which the bending of the sheet P increases is low. Even when the sheet P is a thick paper or a sheet having high rigidity, the force applied in the direction in which the bending of the sheet P increases does not influence the conveyance property of the one-sheet feeding mechanism 73. Even when the sheet P is the thick paper or the sheet having high rigidity, the one-sheet feeding mechanism 73 certainly feeds only the uppermost sheet P to the transport roller 24.

According to the second embodiment, the stepped portion 88 receives the force generated in the sheet P traveling along the second curved conveyance path 84. Accordingly, similarly to the first embodiment, the influence exerted on the separation roller 76 by the force applied in the direction in which the bending generated in the sheet P increases can be made very small. The one-sheet feeding mechanism 73 can send only one sheet certainly to the transport roller 24 irrespective of the kind of the sheet P. A paper jam due to defective feeding of the one-sheet feeding mechanism 73 can be prevented.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

What is claimed is:

1. A conveying device comprising:
a first curved guide member;
a second guide member which has a radius of curvature larger than the first guide member and guides a recording medium between the second guide member and the first guide member;
a pinching and conveying section which is disposed on an entrance side of a conveyance path including the first guide member and the second guide member, pinches the recording medium and conveys the recording medium into the conveyance path; and
a support member which is provided on the second guide member at a position adjacent to the pinching and conveying section, and has a support point on an extended line of a normal line of a nip of the pinching and conveying section.

2. The device of claim 1, wherein the support member is integral with the second guide member.

3. The device of claim 1, wherein the support member is formed stepwise on the second guide member.

4. The device of claim 1, wherein the support member is a protrusion disposed on a surface of the second guide member.

5. The device of claim 1, wherein the pinching and conveying section includes a first roller and a second roller which exists at an outside of the first roller with respect to a curve of the conveyance path and contacts with the first roller,
the first roller is fixed, and the second roller comes in press contact with the first roller from the outside of the curve of the conveyance path.

6. The device of claim 5, wherein the first roller rotates in a direction in which the recording medium enters the conveyance path, and the second roller rotates in a direction in which the recording medium is discharged from the conveyance path.

7. The device of claim 6, wherein when the one recording medium is pinched at the nip, the second roller is driven by the recording medium.

8. The device of claim 1, wherein the support member is provided at a corresponding position of both sides of the pinching and conveying section of the second guide member.

9. An image forming apparatus comprising:
an image forming section configures to form a toner image on an image carrier;
a transfer section configures to transfer the toner image to a recording medium from the image forming section;
a fixing section configures to fix the toner image transferred to the recording medium;
a paper discharge section configures to receive the recording medium passing through the fixing section;
a paper feed section configures to supply the recording medium; and
a conveying device which disposed between the paper feed section and the paper discharge section, including a first curved guide member, a second guide member which has a radius of curvature larger than the first guide member and guides the recording medium between the second guide member and the first guide member, a pinching and conveying section which is disposed on an entrance side of a conveyance path including the first guide member and the second guide member, pinches the recording medium and conveys the recording medium into the conveyance path, and a support member which is provided on the second guide member at a position adjacent to the pinching and conveying section, and has a support point on an extended line of a normal line of a nip of the pinching and conveying section.

10. The apparatus of claim 9, wherein the support member is integral with the second guide member.

11. The apparatus of claim 9, wherein the support member is formed stepwise on the second guide member.

12. The apparatus of claim 9, wherein the support member is a protrusion disposed on a surface of the second guide member.

13. The apparatus of claim 9, wherein the pinching and conveying section includes a first roller and a second roller which exists at an outside of the first roller with respect to a curve of the conveyance path and contacts with the first roller,
the first roller is fixed, and the second roller comes in press contact with the first roller from the outside of the curve of the conveyance path.

14. The apparatus of claim 13, wherein the pinching and conveying section is a separation section between the paper feed section and the transfer section.

15. The apparatus of claim 14, wherein the first roller rotates in a direction in which the recording medium enters the conveyance path, and the second roller rotates in a direction in which the recording medium is discharged from the conveyance path.

16. The apparatus of claim 15, wherein when the one recording medium is pinched at the nip, the second roller is driven by the recording medium.

17. The apparatus of claim 9, wherein the support member is provided at a corresponding position of both sides of the pinching and conveying section of the second guide member.

18. A conveying method of a recording medium, comprising:
conveying a recording medium into a curved conveyance path; and
directing a traveling direction of the recording medium to an inside direction of the curved conveyance path with respect to a traveling direction at an entrance of the conveyance path before the recording medium which entering the conveyance path collides with a guide member.

19. The method of claim 18, wherein the recording medium is supported in the guide member from an outside of a curve after the recording medium enters the conveyance path and before the recording medium contacts with the guide member.
